(19) United States
(12) Patent Application Publication
(10) Pub. No.: US 2026/0172164 A1
(43) Pub. Date: Jun. 18, 2026

(54) COMMUNICATION METHOD AND COMMUNICATION APPARATUS

(71) Applicant: Huawei Technologies Co., Ltd., Shenzhen (CN)

(72) Inventors: Xiaoyan Bi, Shenzhen (CN); Jianglei Ma, Ottawa (CA); Yiqun Ge, Ottawa (CA); Wuxian Shi, Ottawa (CA)

(21) Appl. No.: 19/401,126

(22) Filed: Nov. 25, 2025

Related U.S. Application Data
(63) Continuation of application No. PCT/CN2023/117566, filed on Sep. 7, 2023.
(60) Provisional application No. 63/506,714, filed on Jun. 7, 2023.

(51) Int. Cl. H04L 5/00; H04L 27/26

(52) U.S. Cl. CPC H04L 5/0044; H04L 27/261

(57) ABSTRACT

Embodiments of the present application provide a communication method and a communication apparatus. The method includes: receiving first reference signals; and performing channel estimation based on the first reference signals and first assistance information, the first assistance information corresponds to second assistance information, and the second assistance information is used to assist in channel estimation corresponding to second reference signals, the first reference signals are downlink reference signals, and the second reference signals are uplink reference signals; or, the first reference signals are uplink reference signals, and the second reference signals are downlink reference signals.

### CROSS-REFERENCE TO RELATED APPLICATIONS

This application is a continuation of International Application No. PCT/CN2023/117566, filed on Sep. 7, 2023, which claims priority to U.S. provisional Patent Application No. 63/506,714, filed on Jun. 7, 2023. The disclosures of the aforementioned applications are hereby incorporated by reference in their entireties.

### TECHNICAL FIELD

Embodiments of the present application relate to the field of communications, and more specifically, to a communication method and a communication apparatus.

### BACKGROUND

In a wireless communication system, to implement functions such as system synchronization, channel information feedback, and data transmission, channel estimation needs to be performed on an uplink channel or a downlink channel.

For performing the channel estimation, reference signals could be transmitted between a receiving apparatus and a transmitting apparatus. How the reference signals are used to perform the channel estimation is an urgent problem to be solved.

### SUMMARY

Embodiments of the present application provide a communication method and a communication apparatus. The technical solutions may improve channel estimation performance.

According to a first aspect, an embodiment of the present application provides a communication method, and the method could be performed by a receiving apparatus. The receiving apparatus is a communication device (for example, a base station or a UE) or a chip in the communication device. The method includes: receiving first reference signals; and performing a first channel estimation based on the first reference signals and first assistance information, where the first assistance information has a relationship with second assistance information, and a second channel estimation is based on the second assistance information and second reference signals, where the first reference signals are downlink reference signals, and the second reference signals are uplink reference signals; or, the first reference signals are uplink reference signals, and the second reference signals are downlink reference signals.

According to the above technical solution, assistance information used for channel estimation in uplink transmission and assistance information used for channel estimation in downlink transmission are corresponding. Thus an apparatus (e.g. the receiving apparatus, or the transmitting apparatus) could determine one piece of assistance information based on the other piece of assistance information. The solution may improve channel estimation performance and save signaling overhead compared to a solution of determining the second assistance information and the first assistance information separately.

In a possible design, the method further includes: transmitting the second assistance information, where the second assistance information is determined based on the first assistance information.

According to the above technical solution, the second assistance information could be determined based on the first assistance information, which may improve channel estimation performance compared to a solution of determining the second assistance information and the first assistance information separately.

In a possible design, the first reference signals are downlink reference signals, and the second reference signals are uplink reference signals.

In a possible design, the method further includes: transmitting the second reference signals.

In a possible design, a pattern of the second reference signals is generated based on the first assistance information.

In a possible design, the method further includes: receiving information for indicating to generate the pattern of the second reference signals based on the first assistance information.

According to the above technical solution, the receiving apparatus could determine the pattern of the second reference signals is generated based on the first assistance information based on indication information.

In a possible design, the first assistance information is determined based on the second assistance information.

In a possible design, the method further includes: transmitting or receiving capability information indicating support a function of a correspondence between the first assistance information and the second assistance information.

According to a second aspect, an embodiment of the present application provides a communication method, and the method could be performed by a receiving apparatus. The receiving apparatus is a communication device (for example, a base station or a UE) or a chip in the communication device. The method includes: receiving first assistance information, a first channel estimation based on first reference signals and the first assistance information; determining second assistance information based on the first assistance information, a second channel estimation based on second reference signals and the second assistance information; where the first reference signals are downlink reference signals, and the second reference signals are uplink reference signals; or, the first reference signals are uplink reference signals, and the second reference signals are downlink reference signals.

In a possible design, the method further includes: transmitting the second assistance information.

Various implementations of the second aspect correspond to various implementations of the first aspect. For the various implementations and the beneficial technical effects of the various implementations of the second aspect, reference may be made to the descriptions of the relevant implementations of the first aspect, which will not be repeated here.

According to a third aspect, a communication apparatus is provided, configured to perform the method in any possible implementation of the foregoing aspects. Specifically, the apparatus includes a unit configured to perform the method in any possible implementation of the foregoing aspects.

According to a fourth aspect, another communication apparatus is provided, including a processor. The processor is coupled to a memory, and may be configured to execute one or more instructions in the memory, to implement the method in any possible implementation of the first aspect to the seventh aspect. The memory may be an on-chip storage unit inside the processor, or may be an off-chip storage unit that is coupled to the memory and located outside the processor. In a possible implementation, the apparatus further includes the memory. In a possible implementation, the apparatus further includes a communication interface, and the processor is coupled to the communication interface.

In a possible design, the communication apparatus may be a transmitting apparatus (for example, a base station or a user equipment), may be a chip, a circuit, or a processing system configured in the transmitting apparatus, or may be a device including the transmitting apparatus.

In a possible design, the communication apparatus may be a receiving apparatus (for example, a base station or a user equipment), may be a chip, a circuit, or a processing system configured in the receiving apparatus, or may be a device including the receiving apparatus.

According to a fifth aspect, a computer-readable storage medium is provided. The computer-readable storage medium stores a computer program, and when the computer program is executed by a communication apparatus, the communication apparatus is enabled to implement the method in any possible implementation of the foregoing aspects.

According to a sixth aspect, a computer program product including one or more instructions is provided. When the instructions are executed by a computer, a communication apparatus is enabled to implement the method in any possible implementation of the foregoing aspects.

According to a seventh aspect, a communication system is provided, including the foregoing transmitting apparatus and the foregoing receiving apparatus.

### DESCRIPTION OF DRAWINGS

FIG. 1 is a schematic diagram of an application scenario according to this application;

FIG. 2 illustrates an example communication system 100;

FIG. 3 illustrates another example of an electronic device (ED) 110 and a base station 170a, 170b and/or 170c;

FIG. 4 is an example of a channel model of a multiple-input multiple-output (MIMO) system;

FIG. 5 is an example of a process in which the base station obtains channel state information (CSI);

FIG. 6 is a schematic flowchart of a communication method 600 according to an embodiment of this application;

FIG. 7 is a schematic interaction diagram of a communication method 700 applicable to an embodiment of this application;

FIG. 8 is a schematic block diagram of a communication apparatus according to an embodiment of this application;

FIG. 9 is a schematic block diagram of another communication apparatus according to an embodiment of this application;

FIG. 10 is a flow chart of embodiment 1; and

FIG. 11 illustrates units or modules in a device.

### DETAILED DESCRIPTION OF THE ILLUSTRATIVE EMBODIMENTS

The following describes technical solutions of the present application with reference to the accompanying drawings.

The technical solutions in embodiments of this application may be applied to multiple-input multiple-output (MIMO) technology. And the technical solutions in embodiments of this application may be applied to various communication systems, such as a fifth generation (5G) wireless communication system, a new ratio (NR) wireless communication system, a Long Term Evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

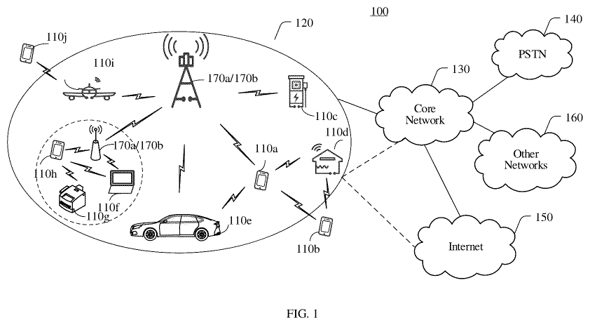

For ease of understanding of the embodiments of this application, a communication system shown in FIG. 1-FIG. 3 is used as an example to describe in detail a communication system to which the embodiments of this application are applicable.

Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as ED 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the Internet 150, and other networks 160.

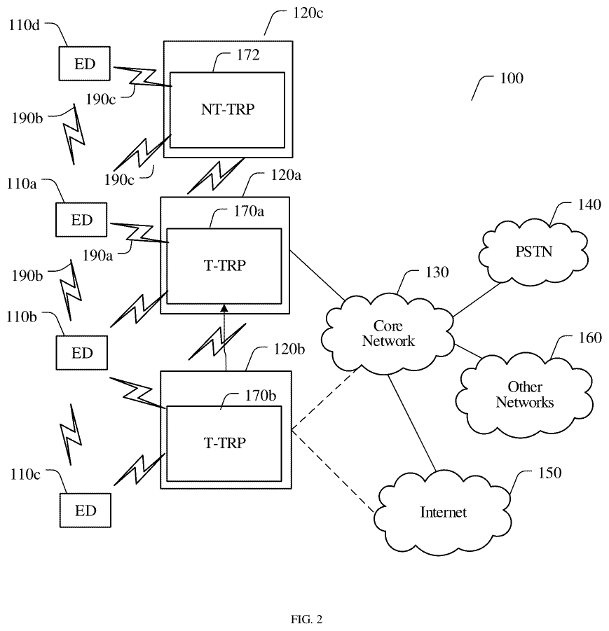

Referring to FIG. 2, an example communication system 100 is illustrated. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such.

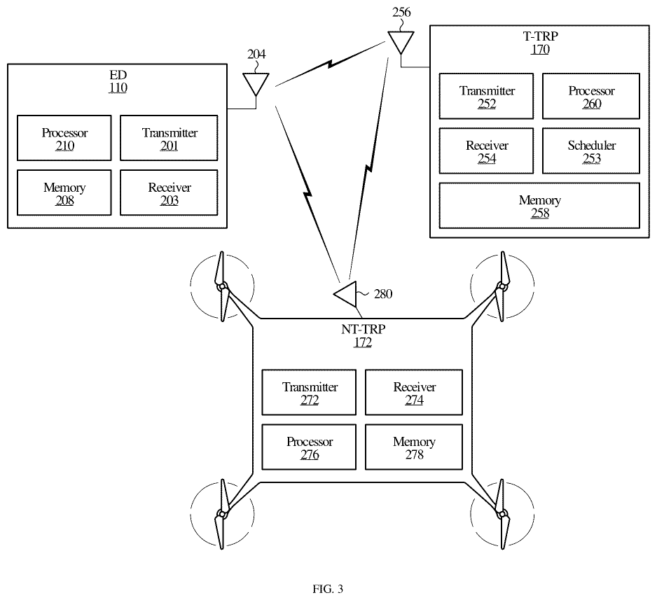

Referring to FIG. 3, another example of an ED 110 and a base station 170a, 170b and/or 170c is illustrated. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or an apparatus (e.g. a communication module, a modem, or a chip) in the forgoing devices, among other possibilities. Future generation EDs 110 may be referred to as other terms. The base station 170a and 170b is a T-TRP and will hereafter be referred to as T-TRP 170. Also, as shown in FIG. 3, an NT-TRP will hereafter be referred to as NT-TRP 172. Each ED 110 connected to T-TRP 170 and/or NT-TRP 172 can be dynamically or semi-statically turned on (i.e., established, activated, or enabled), turned off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmissions to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be reference signals transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations related to network access (e.g. initial access) and/or downlink synchronization, such as operations related to detecting a synchronization sequence, decoding and obtaining the system information, etc. In some embodiments, the processor 210 may perform channel estimation, e.g. using reference signals received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and the receiver 203 may each be implemented by the same or different one or more processors that are configured to execute instructions stored in a memory (e.g. in memory 208). Alternatively, some or all of the processor 210, and the processing components of the transmitter 201 and the receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. a communication module, a modem, or a chip) in the foregoing devices.

The CU (or CU-control plane (CP) and CU-user plane (UP)), DU or RU may be known by other names in some implementations. For example, in an open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remotely from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations related to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by a scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and executed by the processor 260.

Although not illustrated, the processor 260 may form part of the transmitter 252 and/or the receiver 254. Also, although not illustrated, the processor 260 may implement the scheduler 253. Although not illustrated, the memory 258 may form part of the processor 260.

The processor 260, the scheduler 253, and the processing components of the transmitter 252 and the receiver 254 may each be implemented by the same or different one or more processors that are configured to execute instructions stored in a memory, e.g. in memory 258. Alternatively, some or all of the processor 260, the scheduler 253, and the processing components of the transmitter 252 and the receiver 254 may be implemented using dedicated circuitry, such as an FPGA, a GPU, or an ASIC.

The NT-TRP 172 is illustrated as a drone only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and the receiver 274 may each be implemented by the same or different one or more processors that are configured to execute instructions stored in a memory, e.g. in memory 278. Alternatively, some or all of the processor 276 and the processing components of the transmitter 272 and the receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding of the embodiments of this application, the following briefly describes several terms used in this application.

### 1) Multiple-Input Multiple-Output (MIMO)

MIMO technology allows an antenna array of multiple antennas to perform signal transmissions and receptions to meet high transmission rate requirements. The above ED 110 and T-TRP 170, and/or NT-TRP use MIMO to communicate over wireless resource blocks. MIMO utilizes multiple antennas at the transmitting apparatus and/or receiving apparatus to transmit the wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attention from the academia and the industry. In the large-scale MIMO system, the T-TRP 170 and/or NT-TRP 172 is generally configured with more than ten antenna units (such as 128 or 256), and serves for dozens of the EDs 110. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase in the number of antennas allows each antenna unit to be made smaller and at a lower cost. Using the degree of spatial freedom provided by the large-scale antenna units, the T-TRP 170 and NT-TRP 172 of each cell can communicate with many EDs 110 in the cell on the same time-frequency resource at the same time, thus greatly increasing the spectrum efficiency. A large number of antenna units of the T-TRP 170 and/or NT-TRP 172 also enable each user to have better spatial directivity for uplink and downlink transmission, so that the transmitting power of the T-TRP 170 and/or NT-TRP 172 and an ED 110 is reduced, and the power efficiency is greatly increased. When the number of antennas of the T-TRP 170 and/or NT-TRP 172 is sufficiently large, random channels between each ED 110 and the T-TRP 170 and/or NT-TRP 172 can be close to be orthogonal, and the interference between the cell and the users and the effect of noises can be eliminated. The plurality of advantages described above enable the large-scale MIMO to have a magnificent application prospect.

A MIMO system may include a receiving apparatus connected to a receive (Rx) antenna, a transmitting apparatus connected to a transmit (Tx) antenna, and a signal processor connected to the transmitting apparatus and the receiving apparatus. Each of the Rx antenna and the Tx antenna may include a plurality of antennas. For instance, the Rx antenna may have a ULA antenna array in which the plurality of antennas are arranged in a line at even intervals. When a radio frequency (RF) signal is transmitted through the Tx antenna, the Rx antenna may receive a signal reflected and returned from a forward target. The receiving apparatus could be an ED (i.e. ED 110) and the transmitting apparatus could be a T-TRP or NT-TRP (i.e. T-TRP 170 or NT-TRP 172), or the receiving apparatus could be a T-TRP or NT-TRP (i.e. T-TRP 170 or NT-TRP 172) and the transmitting apparatus could be an ED (i.e. ED 110).

Referring to FIG. 4, as an illustrative example without limitation, a simplified schematic illustration of a communication scenario is provided. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

Hereafter, a base station is used as an example of T-TRP 170 or NT-TRP 172, and the UE is used as an example of ED 110. A receiving apparatus may be referred to as ED 110 for a downlink transmission, and T-TRP 170 or NT-TRP 172 for an uplink transmission. A transmitting apparatus may be referred to as T-TRP 170 or NT-TRP 172 for a downlink transmission, and ED 110 for an uplink transmission. However, limitation is not made herein.

### 2) Channel Estimation

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, reference signals predicted by a transmitting apparatus and a receiving apparatus may be used to track a change in the time domain and/or frequency domain of a channel, so as to reconstruct or restore a received signal. The reference signals may also be referred to as a pilot signal, a reference sequence or the like, and are described as reference signals in the following for ease of understanding. The reference signal includes, for example, a channel state information-reference signal (CSI-RS), a sounding reference signal (SRS), a demodulation reference signal (DMRS), a phase track reference signal (PT-RS), or a cell reference signal (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e. a UE) may perform channel estimation on each physical antenna port based on a CSI-RS sent by a transmitting apparatus ((i.e. a base station), to feedback channel state information (CSI) based on a channel estimation result. The CSI may include one or more of: a channel quality indicator (CQI), a precoding matrix indicator (PMI), and a layer indicator (LI). The CSI is used to reconstruct or precode the downlink channel. In some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

In an implementation, a transmitting apparatus maps a sequence of reference signals to certain physical resources, and transmits the reference signals over the certain physical resources, where the sequence of reference signals and the physical resources are known to both the transmitting apparatus and the receiving apparatus receiving the reference signals. Thus, the receiving apparatus could perform channel estimation based on the received reference signals.

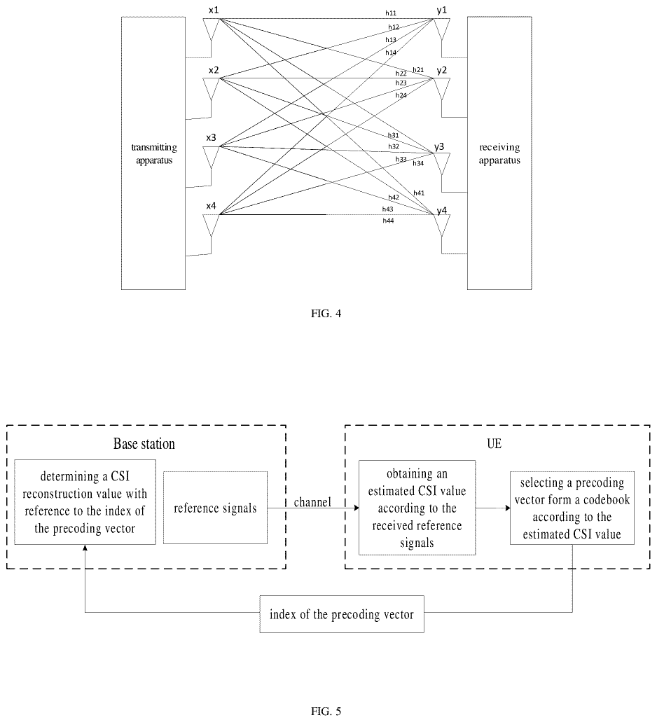

Referring to FIG. 5, in some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

The process of transmitting reference signals described below may be performed by a base station, or may be performed by a UE. The process of measuring a channel may be performed by the UE when the base station transmits the reference signals, and may be performed by the base station when the UE transmits the reference signals. For ease of description, an apparatus that transmits the reference signals is herein after referred to as a transmitting apparatus and an apparatus that measures a channel based on the reference signals is herein after referred to as a receiving apparatus.

### 3) Antenna Port

An antenna port, which may also be referred to as port for short, is a transmitting antenna identified by a receiver, or a transmitting antenna that can be distinguished in spatial domain. For each virtual antenna, one antenna port may be configured, and each virtual antenna may be a weighted combination of multiple physical antennas. Each antenna port may correspond to one reference signals port.

### 4) Quasi-Co-Location (QCL)

Two antenna ports are said to be quasi co-located if the large-scale properties (or channel features) of the channel over which a symbol on one antenna port is conveyed can be inferred from the channel over which a symbol on the other antenna port is conveyed.

The large-scale properties (or channel features) may include one or more of the following: delay spread, Doppler spread, Doppler shift, average delay, average gain, and Spatial RX parameter. The spatial RX parameter may include, for example, angle of arrival (AOA), average AOA, AOA spread, angle of departure (AOD), average AOD, AOD spread, and RX antenna spatial correlation parameter, Tx antenna spatial correlation parameter, transmit beam, receive beam, resource identifier, and the like.

The angle mentioned above may be decomposition values of different dimensions, or a combination of decomposition values of different dimensions. The two antenna ports mentioned above may be antenna ports with different antenna port numbers, and/or, antenna ports with a same antenna port number that send or receive information in different time and/or frequency and/or code domain resources, and/or, the antenna ports with different antenna port numbers send or receive information in different time and/or frequency and/or code domain resources. The resource identifier may include, for example, a CSI-RS resource identifier, an SRS resource identifier, a synchronization signal/synchronization signal block resource identifier, a demodulation reference signal (DMRS) resource identifier, or a resource identifier of preamble sequence transmitted on a physical random access channel (PRACH).

### 5) Assistance Information

The assistance information indicates a relationship between different channels. Specifically, a receiving apparatus receives reference signals, and performs channel estimation based on the reference signals to obtain first channel coefficients corresponding to a first channel; and the receiving apparatus could obtain second channel coefficients corresponding to a second channel based on the first channel coefficients and assistance information, where the assistance information indicates a relationship between the first channel and the second channel. Based on the foregoing technical solution, the receiving apparatus could obtain the second channel coefficients based on the first channel coefficients and the assistance information, and thus a transmitting apparatus does not need reference signals for performing channel estimation to obtain the second channel coefficients.

The channel coefficients represent one or more values of a channel matrix. For example, the receiving apparatus performs channel estimation based on the reference signals, and determines a matrix of the first channel based on a channel estimation result, and values of the matrix of the first channel could be referred to as the first channel coefficients.

In some embodiments, the assistance information may comprise: matrix based information, vector based information, tensor based information, and manifold information.

As described above, the assistance information and coefficients of one channel could be used to obtain coefficients of the other channel. Then, how the assistance information is used in uplink transmission and downlink transmission becomes a problem to be solved.

In view of this, the embodiments of this application provide a method to solve the problem. Specifically, assistance information used for channel estimation in uplink transmission and assistance information used for channel estimation in downlink transmission are corresponding, and thus an apparatus could determine one piece of assistance information based on the other piece of assistance information. The solution may improve channel estimation performance and save signaling overhead compared to a solution of determining the second assistance information and the first assistance information separately.

The following describes the embodiments of this application in detail with reference to the accompanying drawings.

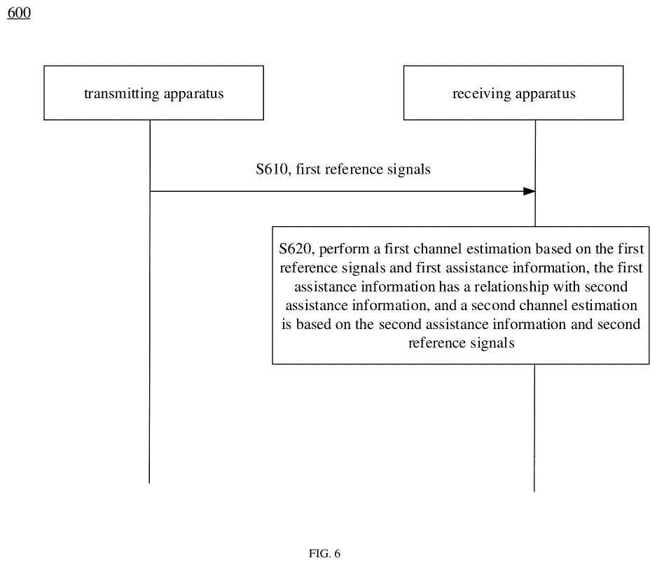

Referring to FIG. 6, a schematic flowchart of a communication method 600 according to an embodiment of this application is shown. The communication method 600 may be applied to the communication system 100 shown in FIG. 1.

At S610, a receiving apparatus receives first reference signals.

Correspondingly, a transmitting apparatus transmits the first reference signals.

At S620, the receiving apparatus performs a first channel estimation based on the first reference signals and first assistance information, the first assistance information has a relationship with second assistance information, and a second channel estimation is based on the second assistance information and second reference signals.

In a possible implementation, the first reference signals are downlink reference signals, and the second reference signals are uplink reference signals. In this implementation, the first channel estimation represents downlink channel estimation, and the second channel estimation represents uplink channel estimation.

In another possible implementation, the first reference signals are uplink reference signals, and the second reference signals are downlink reference signals. In this implementation, the first channel estimation represents uplink channel estimation, and the second channel estimation represents downlink channel estimation.

In this application, the “first channel estimation” is only named for differentiation and does not limit the scope of protection of the embodiments of this application. Similarly, a “second channel estimation” in the application is also only named for differentiation and do not limit the scope of protection of the embodiments of this application.

The first assistance information has a relationship with the second assistance information, therefore an apparatus (e.g. the receiving apparatus, or the transmitting apparatus) could determine the first assistance information based on the second assistance information, or determine the second assistance information based on the first assistance information. In other words, assistance information used for channel estimation in downlink transmission could be reused for channel estimation in uplink transmission, or, assistance information used for channel estimation in uplink transmission could be reused for channel estimation in downlink transmission.

That the apparatus (e.g. the receiving apparatus, or the transmitting apparatus) determines the first assistance information based on the second assistance information may be designed in any one of the following implementations.

In a possible implementation, the receiving apparatus determines the first assistance information based on the second assistance information.

Specifically, for example, the transmitting apparatus transmits the second assistance information, correspondingly, the receiving apparatus receives the second assistance information, and the receiving apparatus determines the first assistance information based on the second assistance information received.

In another possible implementation, the transmitting apparatus determines the first assistance information based on the second assistance information. Further, the transmitting apparatus transmits the first assistance information, correspondingly, the receiving apparatus receives the first assistance information.

Specifically, for example, the transmitting apparatus determines the second assistance information by itself, and determines the first assistance information based on the second assistance information; then the transmitting apparatus transmits the first assistance information, correspondingly, the receiving apparatus receives the first assistance information.

In another possible implementation, other apparatus determines the first assistance information based on the second assistance information. Further, the other apparatus transmits the first assistance information, correspondingly, the receiving apparatus receives the first assistance information.

Specifically, for example, the transmitting apparatus transmits the second assistance information, correspondingly, the other apparatus receives the second assistance information, and the other apparatus determines the first assistance information based on the second assistance information received; then the other apparatus transmits the first assistance information, correspondingly, the receiving apparatus receives the first assistance information.

That the apparatus (e.g. the receiving apparatus, or the transmitting apparatus) determines the second assistance information based on the first assistance information may refer to the implementations above. Details are not described herein again.

Based on the foregoing technical solution, assistance information used for channel estimation in uplink transmission and assistance information used for channel estimation in downlink transmission are corresponding. Thus an apparatus (e.g. the receiving apparatus, or the transmitting apparatus) could determine one piece of assistance information based on the other piece of assistance information. The solution may improve channel estimation performance, and save signaling overhead.

The following are detailed implementations of the application.

Case 1: The first reference signals are downlink reference signals, and the second reference signals are uplink reference signals. For example, the first reference signals are CSI-RSs, and the second reference signals are SRSs.

In this case, the receiving apparatus is a UE, and the transmitting apparatus is a base station.

The first assistance information is used to assist in channel estimation corresponding to the first reference signals, and the second assistance information is used to assist in channel estimation corresponding to the second reference signals could be interpreted as: the first assistance information is used for downlink transmission, and the second assistance information is used for uplink transmission.

In some embodiments, the receiving apparatus determines the first assistance information. Then the receiving apparatus could perform channel estimation based on the first reference signals and the first assistance information.

In a possible implementation, the receiving apparatus receives the first assistance information. For example, the transmitting apparatus transmits the first assistance information, and the receiving apparatus receives the first assistance information.

In this implementation, for example, the receiving apparatus transmits the second assistance information, and the second assistance information is determined based on the first assistance information. Specifically, the first assistance information corresponds to the second assistance information, therefore the receiving apparatus could determine the second assistance information based on the first assistance information received, and the receiving apparatus transmits the second assistance information. Correspondingly, the transmitting apparatus could receive the second assistance information.

Further, for example, the receiving apparatus transmits the second reference signals. Correspondingly, the transmitting apparatus receives the second reference signals, and the transmitting apparatus could perform channel estimation based on the second reference signals and the second assistance information.

For example, a pattern of the second reference signals could be generated based on the first assistance information. Specifically, the first assistance information corresponds to the second assistance information, therefore the receiving apparatus could generate the pattern of the second reference signals based on the first assistance information.

The receiving apparatus could determine the pattern of the second reference signals is generated based on the first assistance information by itself. Or, the receiving apparatus could determine the pattern of the second reference signals is generated based on the first assistance information based on indication information. For example, the receiving apparatus receives information for indicating the pattern of the second reference signals is generated based on the first assistance information, and in response to this information, the receiving apparatus generates the pattern of the second reference signals based on the first assistance information.

In another possible implementation, the receiving apparatus determines the first assistance information by itself. For example, the receiving apparatus determines the first assistance information based on the second assistance information.

In some embodiments, the receiving apparatus transmits/receives capability information indicating whether to support processing the function of a correspondence between the first assistance information and the second assistance information. The correspondence refers to the first assistance information corresponds to the second assistance information.

For an example, the receiving apparatus transmits the capability information, and the transmitting apparatus receives the capability information, and according to the capability information, the transmitting apparatus transmits the information for indicating the pattern of the second reference signals is generated based on the first assistance information.

For another example, the receiving apparatus transmits the capability information, and the transmitting apparatus receives the capability information, and according to the capability information, the transmitting apparatus determines the second assistance information based on the first assistance information.

For another example, the receiving apparatus receives the capability information, and the transmitting apparatus transmits the capability information, and according to the capability information, the receiving apparatus determines the second assistance information based on the first assistance information.

Case 2: The first reference signals are uplink reference signals, and the second reference signals are downlink reference signals. For example, the first reference signals are SRSs, and the second reference signals are CSI-RSs.

In this case, the receiving apparatus is a base station, and the transmitting apparatus is a UE.

The first assistance information is used to assist in channel estimation corresponding to the first reference signals, and the second assistance information is used to assist in channel estimation corresponding to the second reference signals could be interpreted as: the first assistance information is used for uplink transmission, and the second assistance information is used for downlink transmission.

In some embodiments, the receiving apparatus determines the first assistance information. This embodiment could refer to Case 1, and for brevity, details are not described herein again.

In some embodiments, the receiving apparatus receives/transmits capability information indicating whether to support process a function of a correspondence between the first assistance information and the second assistance information. This embodiment could refer to Case 1, and for brevity, details are not described herein again.

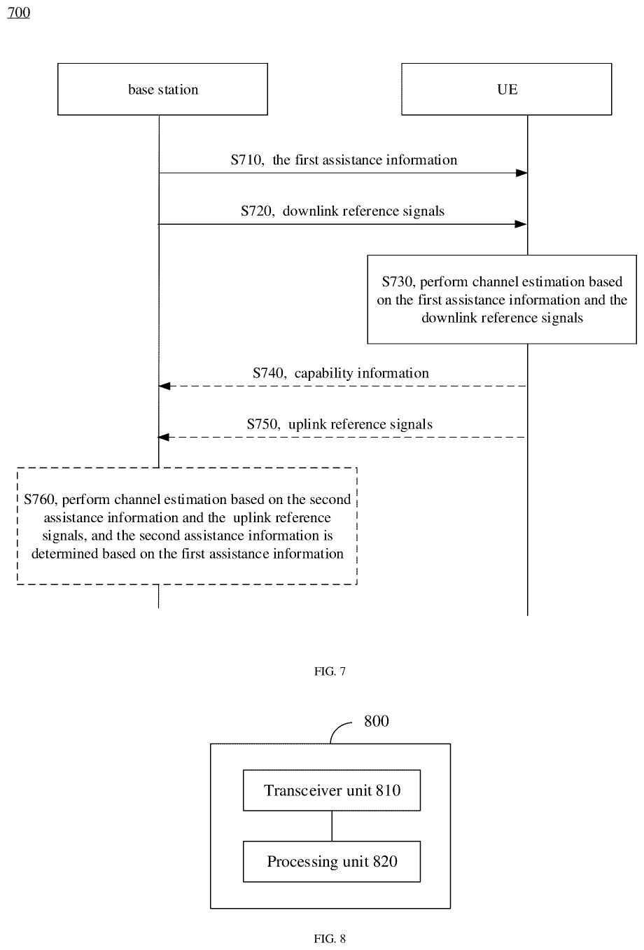

The following provides a detailed example for description with reference to FIG. 7.

Referring to FIG. 7, a schematic interaction diagram of a communication method 700 applicable to an embodiment of this application is shown. In the method 700, the receiving apparatus is a UE, the transmitting apparatus is a base station, the first reference signals are downlink reference signals, and the second reference signals are uplink reference signals. The method 700 may include the following steps.

In some embodiments, the method 700 includes S710.

At S710, the base station transmits the first assistance information.

Correspondingly, the UE receives the first assistance information.

The first assistance information is used for downlink transmission, in other words, the first assistance information is used to assist in channel estimation corresponding to downlink reference signals.

At S720, the base station transmits downlink reference signals.

Correspondingly, the UE receives the downlink reference signals. For example, the downlink reference signals are CSI-RSs.

At S730, the UE performs channel estimation based on the first assistance information and the downlink reference signals.

For example, the UE performs channel estimation (that is the first channel estimation) based on the downlink reference signals to obtain first channel coefficients corresponding to a first channel; and the UE could obtain second channel coefficients corresponding to a second channel based on the first channel coefficients and the first assistance information, where the first assistance information indicates a relationship between the first channel and the second channel.

In some embodiments, the method 700 includes S740-S760.

At S740, the UE transmits capability information.

The capability information indicates whether to support processing the function of a correspondence between the first assistance information and the second assistance information.

Correspondingly, the base station receives the capability information. According to the capability information, the base station obtains that the first assistance information corresponds to the second assistance information. For example, the base station could obtain that assistance information for downlink Rx antenna ports/RF chains could be reused for uplink Tx antenna ports/RF chains.

At S750, the UE transmits uplink reference signals.

Correspondingly, the base station receives the uplink reference signals. For example, the uplink reference signals are SRSs. In some embodiments, a pattern of the uplink reference signals could be generated based on the first assistance information.

At S760, the base station performs channel estimation based on the second assistance information and the uplink reference signals, and the second assistance information is determined based on the first assistance information.

That is the base station performs second channel estimation based on the second assistance information and the uplink reference signals.

In the embodiments of this application, “and/or” describes an association relationship between associated objects and represents that three relationships may exist. For example, A and/or B may represent the following three cases: only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: only A exists, both A and B exist, and only B exists.

The methods according to embodiments of this application are described above in detail with reference to FIGS. 6-7. The apparatuses provided in embodiments of this application are described below in detail with reference to FIGS. 8-9. Description of apparatus embodiments corresponds to the description of the method embodiments. Therefore, for content that is not described in detail, refer to the foregoing method embodiments. For brevity, details are not described herein again.

The communication method according to the embodiments of this application is described in detail above with reference to FIGS. 6-7, and the transmitting apparatus and the receiving apparatus according to the embodiments of this application will be described in detail below with reference to FIGS. 8-9

Referring to FIG. 8, a schematic block diagram of a communication apparatus according to an embodiment of this application is shown. The communication apparatus 800 includes a transceiver unit 810 and a processing unit 820. The transceiver unit 810 may implement a corresponding communication function, and the processing unit 810 is configured to perform data processing. The transceiver unit 810 may also be referred to as a communication interface or a communication unit.

In some embodiments, the communication apparatus 800 may further include a storage unit. The storage unit may be configured to store instructions and/or data. The processing unit 820 may read instructions and/or data in the storage unit, to enable the communication apparatus to implement the foregoing method embodiments.

The communication apparatus 800 may be configured to perform actions performed by the transmitting apparatus in the foregoing method embodiments. In this case, the communication apparatus 800 may be the transmitting apparatus or a component that can be configured in the transmitting apparatus. The transceiver unit 810 is configured to perform receiving/transmitting-related operations on the transmitting apparatus side in the foregoing method embodiments. The processing unit 820 is configured to perform processing-related operations on the transmitting apparatus side in the foregoing method embodiments.

Alternatively, the communication apparatus 800 may be configured to perform actions performed by the receiving apparatus in the foregoing method embodiments. In this case, the communication apparatus 800 may be the receiving apparatus or a component that can be configured in the receiving apparatus. The transceiver unit 810 is configured to perform receiving/transmitting-related operations on the receiving apparatus side in the foregoing method embodiments. The processing unit 820 is configured to perform processing-related operations on the receiving apparatus side in the foregoing method embodiments.

In a design, the communication apparatus 800 is configured to perform actions performed by the receiving apparatus in the foregoing method embodiments.

In an implementation, the transceiver unit 810 is configured to receive first reference signals; the processing unit 820 is configured to perform a first channel estimation based on the first reference signals and first assistance information, the first assistance information has a relationship with second assistance information, and a second channel estimation is based on second reference signals and the second assistance information, where the first reference signals are downlink reference signals, and the second reference signals are uplink reference signals; or, the first reference signals are uplink reference signals, and the second reference signals are downlink reference signals.

The communication apparatus 800 may implement steps or procedures performed by the receiving apparatus in FIG. 6 and UE in FIG. 7 according to embodiments of this application. The communication apparatus 800 may include units configured to perform the methods performed by the receiving apparatus in FIG. 6 and UE in FIG. 7. In addition, the units in the communication apparatus 800 and the foregoing other operations and/or functions are separately used to implement corresponding procedures in FIGS. 6-7.

In another design, the communication apparatus 800 is configured to perform actions performed by the transmitting apparatus in the foregoing method embodiments.

In an implementation, the transceiver unit 810 is configured to receive first assistance information, a first channel estimation based on first reference signals and the first assistance information; and the processing unit 820 is configured to determine second assistance information based on the first assistance information, a second channel estimation based on second reference signals and the second assistance information, where the first reference signals are downlink reference signals, and the second reference signals are uplink reference signals; or, the first reference signals are uplink reference signals, and the second reference signals are downlink reference signals.

The communication apparatus 800 may implement steps or procedures performed by the transmitting apparatus in FIG. 6 and base station in FIG. 7 according to embodiments of this application. The communication apparatus 800 may include units configured to perform the methods performed by the transmitting apparatus in FIG. 6 and base station in FIG. 7. In addition, the units in the communication apparatus 800 and the foregoing other operations and/or functions are separately used to implement corresponding procedures in FIGS. 6-7.

A specific process in which the units perform the foregoing corresponding steps is described in detail in the foregoing method embodiments. For brevity, details are not described herein again.

Referring to FIG. 9, a schematic block diagram of another communication apparatus according to an embodiment of this application is shown. The communication apparatus 900 includes a processor 910. The processor 910 is coupled to a memory 920. The memory 920 is configured to store a computer program or instructions and/or data. The processor 910 is configured to execute the computer program or instructions and/or data stored in the memory 920, so that the methods in the foregoing method embodiments are executed.

In some embodiments, the communication apparatus 900 includes one or more processors 910.

In an example, as shown in FIG. 9, the communication apparatus 900 may further include the memory 920.

In some embodiments, the communication apparatus 900 may include one or more memories 920.

In an example, the memory 920 may be integrated with the processor 910, or disposed separately from the processor 910.

In an example, as shown in FIG. 9, the communication apparatus 900 may further include a transceiver 930, where the transceiver 930 is configured to receive and/or transmit a signal. For example, the processor 910 may be configured to control the transceiver 930 to receive and/or transmit a signal.

In a solution, the communication apparatus 900 is configured to perform the operations performed by the transmitting apparatus in the foregoing method embodiments.

For example, the processor 910 may be configured to perform a processing-related operation performed by the transmitting apparatus in the foregoing method embodiments, and the transceiver 930 is configured to perform a receiving/transmitting-related operation performed by the transmitting apparatus in the foregoing method embodiments.

In another solution, the communication apparatus 900 is configured to perform the operations performed by the receiving apparatus in the foregoing method embodiments.

For example, the processor 910 may be configured to perform a processing-related operation performed by the receiving apparatus in the foregoing method embodiments, and the transceiver 930 may be configured to perform a receiving/transmitting-related operation performed by the receiving apparatus in the foregoing method embodiments.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer may be enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

### a Method and Apparatus of Pairing Multiple Users in a Very Large MIMO System

Acronyms and Abbreviations

| Full Name | Acronym/Abbreviation/Initialism |
|---|---|
| MIMO | Multiple-In-Multiple-Out |
| T-MIMO | Terabit Multiple In and Multiple Out |
| NR | Next generation radio (=5G) |
| gNB | |
| BS | Base-station |
| UE | User-equipment |
| Tx | Transmitter |
| Rx | Receiver |
| SU | Single-User |
| MU | Multiple-User |
| RE | Resource Element |
| SVD | Singular Vector Decomposition |
| SNR | Signal-to-Noise Ratio |
| DL | Downlink |
| UL | Uplink |
| TDD | Time Division Duplex |
| FDD | Frequency Division Duplex |
| SRS | Sounding reference signals |
| TTI | Time Transmission Interval |
| RF | RadiFrequency |
| IF | Intermediate frequency |
| MAI | Multiple-Access-Interference |
| CSI-RS | Channel State Information Reference Signal |
| PMI | Precoding matrix index |
| RI | Rank index |
| Pivot-QRD | Pivot QR Decomposition |
| EZF | Eigen-Zero Forcing |
| MSE | Mean Square Error |
| LOS | Line of Sight |
| NLOS | Non Light of Sight |
| RT | Ray-Tracing |

### Background

### MIMO and MU-MIMO

MIMO system has been widely deployed in modern wireless systems to improve system capacity and bandwidth efficiency by making use of space diversities among antenna ports. For example, on a given subcarrier or RE, a transceiver made of N_{Tx} Tx antenna ports and N_{Rx} Rx antenna ports consists into a N_{Tx}-by-N_{Rx} MIMO channel represented by a N_{Tx}-by-N_{Rx} complex matrix H_{UE,RE}. The N_{Tx}-by-N_{Rx} MIMO channel can be decomposed via SVD: H_{UE,RE}=Z_{UE,RE}S_{UE,RE}V_{UE,RE}^{H}, where Z_{UE,RE} is a N_{Tx}-by-N_{Tx} square orthonormal matrix (s.t. Z_{UE,RE}^{H}Z_{UE,RE}=I), V_{UE,RE} is a N_{Rx}-by-N_{Rx} square orthonormal matrix (s.t. V_{UE,RE}^{H}V_{UE,RE}=I), and S_{UE,RE} is a N_{Tx}-by-N_{Rx} rectangular diagonal matrix. The rank of H_{UE,RE} is no more than the smaller one between N_{Rx} and N_{Tx}, i.e. r_{UE,RE}=min(N_{Tx},N_{Rx}). Per SVD, if the transmitter applied H and the receiver a receiving matrix V_{UE,RE}, the N_{Tx}-by-N_{Rx} MIMO a precoder matrix Z_{UE,RE} channel would become r_{UE,RE} independent and parallel (orthogonal) subchannels as following:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

Each sub-channel has a scale value channel response (H_{UE,RE} (i)), i.e. i-th diagonal element of S_{UE,RE} (singular value, H_{UE,RE} (i)=S_{UE,RE} (i, i)). Accordingly, SNR on the i-th sub-channel is defined as

$$\frac{{‖ {H}_{UE , RE} ( i ) ‖}^{2}}{N} , i = 1 , 2 , … , {r}_{UE , RE} .$$

In a wireless system, only the sub-channels whose SNRs are higher than a threshold can be considered as effective sub-channels for transmissions. The remaining (or survival) effective sub-channels are called MIMO flows.

This SNR-based truncation scheme turns a standard SVD into a rank-reduced SVD one by discarding those sub-channels whose SNRs are lower than the threshold(s): H_{UE,RE}≈Z_{UE,RE}S_{UE,RE}V_{UE,RE}^{H} (reduced SVD), where Z_{UE,RE} is a N_{Tx}-by-r_{UE,RE} orthonormal matrix (Z_{UE,RE}^{H}Z_{UE,RE}=I), V_{UE,RE} is r_{UE,RE}-by-N_{Rx} orthonormal matrix (V_{UE,RE}^{H}V_{UE,RE}=I), and S_{UE,RE} is r_{UE,RE}-by-r_{UE,RE} square diagonal matrix. The number of MIMO flows of H_{UE,RE} is r_{UE,RE}≤min(N_{Tx}, N_{Rx}). When the transmitter applied a precoder matrix Z_{UE,RE}^{H} and correspondent receiver applied a receiving matrix V_{UE,RE}, the N_{Tx}-by-N_{Rx} MIMO channel would become:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

This time S_{UE,RE} IS a r_{UE,RE}-by-r_{UE,RE} diagonal matrix.

Mathematically speaking, precoder matrix Z_{UE,RE}^{H} at the transmitter and receiving matrix V_{UE,RE} at the receiver synergy the entire MIMO channel on these remaining sub-channels by linear transformations over the MIMO channel H_{UE,RE}. Its MIMO gain or space diversity gain, indicated by the resultant SNRs

$$\frac{{‖ {H}_{UE , RE} ( i ) ‖}^{2}}{N} , i = 1 , 2 , … , {r}_{UE , RE} ,$$

is attributed to inherent space diversity of MIMO channel between transmitter and receiver, which is related to radio environment. Empirically, radio channels in such complex environment as downtown area would tend to have higher number of MIMO flows than in simpler environment, for high buildings entails more space diversity by more reflectivity.

For higher MIMO gain, wireless systems increases the number of antenna ports, that is, N_{Tx} and N_{Rx}, which hoists the upper-bound of the number of MIMO flows, because of r_{UE,RE}≤min(N_{Tx}, N_{Rx}). But, in reality, r_{UE,RE} is much smaller than its upper-bound, min(N_{Tx}, N_{Rx}). In this context, MU-MIMO was proposed: more than one MIMO channels would be multiplexed by a common precoder W. Imagine that two MIMO channels, H_{UE(1),RE} and H_{UE(2),RE}, on the same RE, are very different from each other; then it is likely to find a common precoder to multiplex both; whereas imagine that two MIMO channels, H_{UE(1),RE} and H_{UE(2),RE}, on the same RE, are almost the same; then it is unlikely to find a common precoder to multiplex both.

Mathematically, this common precoder W is related to precoders Z_{UE(1),RE} and Z_{UE(2),RE}. Concatenate both into one by [symbol] =[Z_{UE(1),RE} Z_{UE(2),RE}] where z is a N_{Tx}-by-(r_{UE(1),RE}+r_{UE(2),RE}) matrix. Their common precoder is W= [symbol] ( [symbol] ^{H} [symbol] )⁻¹ where W is a N_{Tx}-by-(r_{UE(1),RE}+r_{UE(2),RE}) matrix. If Z_{UE(1),RE} and Z_{UE(2),RE} are orthogonal, [symbol] ^{H} [symbol] approaches an identity matrix, W= [symbol] =[Z_{UE(1),RE} Z_{UE(2),RE}], meaning that the transmitter can continue using precoder matrix Z_{UE(1),RE} for UE-1 and precoder matrix Z_{UE(2),RE} for UE-2 to multiplex on this RE on the same time without MAI. If Z_{UE(1),RE} and Z_{UE(2),RE} are the same, [symbol] ^{H} [symbol] approaches a singular matrix (irreversible) so that no common precoder W is available. These two UEs cannot be paired together. Most practical cases are within the two extreme examples. [symbol] ^{H} [symbol] is neither an identity matrix nor a singular matrix. Transmitter has to compute the common precoders for all the possible combinations and then find the best one. Unfortunately, it is a NP-hard problem. Suppose that a transmitter has 200 candidate receivers. In theory, this transmitter has to make an exhaustive search among

$${\sum }_{i = 2}^{200} ( \begin{matrix}i \\ 200\end{matrix} )$$

times different common precoder W computation for different combinations of receivers. Besides, in order to increase the extent to which [symbol] ^{H} [symbol] approaches an identity matrix and pair more receivers, we usually makes N_{Tx}>>Σᵢ r_{UE(i),RE}, motivating wireless systems to adopt more antenna ports or more precisely higher MIMO antenna port ratio between transmitter and receiver (N_{Tx}/N_{Rx}).

After the common precoder W is computed, the transmitter would multiply it to its transmitted signals.

### MU-MIMO Engineering Tradeoffs

For a wireless system, MU-MIMO is usually used in DL in which BS is transmitter and UEs are receivers. MIMO channels of multiple UEs are paired by a common precoder W to multiplex on the same REs (frequency) and the same time durations (timing).

To meet high throughput and system efficiency's end, modern MU-MIMO system has lots of antenna ports across a wide band. For example, in a T-MIMO system (of 6G), it is expected that BS has 1024 antenna ports and UE has 32 antenna ports over 500 MHz bandwidth. The MIMO channel of a UE becomes a three-dimensional tensor (N_{RE}-by-N_{Tx}-by-N_{Rx}).

### Major Tradeoff-1: Assumption on DL/UL Channel Reciprocity

Although MU-MIMO pairing is achieved over the DL channels between one BS and multiple UEs, it is impracticable for each associated UE to report or feedback its DL channel estimation to the BS, because it would result into a huge UL feedback overhead due to the large dimensionality of T-MIMO channel. In TDD system, it is assumed that the DL channel between one BS and one UE can be approximated by the UL channel between the BS and the UE. In 4G and 5G-NR systems, SRS UL channel is specified for the UL channel measurement or estimation for this purpose. SRS UL channel is shared by a number of UEs. These UEs send their own SRS reference signals on the SRS pilot positions so that the BS can estimate their UL MIMO channels respectively. In 5G-NR, the sharing is achieved by coding multiplexing on modulation signals.

### Major Tradeoff-2: Random or Quasi-Random MU-Pairing Implementation

As aforementioned, MU-Pairing is a NP-hard problem. In theory, the optimal pairing is a result from an exhaustive search (computation) on all the possible combinations of the candidate UEs, from 2 of them up to all of them. However, the computation that involves a pseudo-inversion of matrix [symbol] is too long for a real-time signal processing during one TTI or several TTIs. In particular, when N_{Tx} is more than hundreds or even thousands and pairing 10 or 20 UEs, the pseudo-inversion of matrix [symbol] could become computation-wisely forbidden for most hardware implementation in several TTIs. Due to the complexity and latency limitations, there is nearly no exhaustive computation to search the best pairing scheme in a practical implementation. Instead, some random or quasi-random selection of a given number of the paired UEs from a big pool of candidates is firstly conducted into [symbol] and then followed by a common precoder matrix computation W= [symbol] ( [symbol] ^{H} [symbol] )⁻¹. Empirically, the selection may consider the positions of the candidate UEs. For example, an empirical selection algorithm may tend to choose the paired UEs far from each other, because it is more likely for these UEs to have orthogonal MIMO channels. For example, the number of the paired is simply given by empirical experience or hardware limitation.

Strictly speaking, the tradeoff doesn't realize the pairing but only compute the precoder matrix W from whichever reversible [symbol] ^{H} [symbol] .

### Assistance Information of LTE and 5G-NR RS

3GPP has introduced Quasi-Colocation (QCL) concept in LTE and 5G-NR to help the UE with channel estimation, frequency offset error estimation and synchronization procedures. For example, if UE knows that the radio channels corresponding to two different antenna ports is QCL in terms of Doppler shift, then UE can determine Doppler shift for one antenna port and then apply the result on both antenna ports for channel estimation. This avoids the UE to calculate doppler for both antenna port separately.

The antenna port can be used for transmission of a physical channel or signal. The antenna port can be defined so that the channel over which a symbol on the antenna port is conveyed can be inferred from the channel over which another symbol on the same antenna port is conveyed. Different antenna ports can correspond to different reference signals, which can be used for channel estimation and processing of the physical channel transmitted on the same antenna ports. Antenna ports that correspond to different reference signals may be located at the same location, or different locations. Each channel of a signal from differently located antenna ports can have substantially different large scale properties due to the different location, different distance from a UE, different signal paths, and so forth. However, antenna ports that are located at different locations may still have similar large scale properties if the distance between the ports is not substantial. These antenna ports can be assumed to have the same large scale properties. They are referred to as being quasi co-located. Two antenna ports can be quasi co-located if the large-scale properties of the channel over which a symbol on one antenna port is conveyed can be inferred from the large-scale properties of the channel over which a symbol on the other antenna port is conveyed.

5G NR have support for multi-antenna transmission, beam-forming, and simultaneous transmission from multiple geographically separates sites (COMP). In such cases, the channels of different antenna ports relevant for a UE may differ even in terms of radio channel properties and QCL antenna port may be geographically separated. Therefore, QCL information actually is a type of assistance information for channel estimation, which utilize the commonality of channel properties among different antenna ports.

### Non-Uniform Pilot Placement Patterns

Both 5G-NR SRS UL Channels and CSI-RS DL channels employs uniform pilot placement patterns, partly because uniform pilot placement patterns are among the safest method to ensure channel estimation performance in particular with little prior-knowledge about the current channel, partly because they are easy to be described, standardized, and aligned (configured) across transceiver. However, uniform pilot placement patterns are one of the lowest efficient patterns. Its density must be designed for the worst case in statistics, which is rare in practice. In another word, uniform pilot placement patterns specified in the 5G-NR standard may as well be over-designed in most practical cases.

In 5G-NR, average density of its uniform pilot placement patterns is about 7%-17% of its radio resource to be used for pilots or reference signals. For example, every RB (made of 12 REs) has one reference signals, resulting into 8.33% (˜1/12) overhead for pilots. If the same uniform density were to be employed in TMIMO, the overhead would be too huge to be processed. At least, it would be impossible for these UEs on the edge to feedback huge CSIs.

### Technical Solution in the Prior Art

The radio channel properties which may be common across the antenna ports includes Doppler spread/shift, average delay, delay spread, average gain and spatial receiver parameters. This properties are known as “large-scale properties”. A short definition of each is given below
Doppler Shift: Doppler shift is a shift in the frequency of the radio signal relative to motion of the receiver. E.g. gNB transmits a radio signal of a frequency “X” however the receiver (UE) is in mobility traveling away from the gNB so that same radio signal due to the distance of the UE by the time it reaches the UE the frequency is changed to “Y”, this phenomenon is known as Doppler shift. A real life example is the sound of a speeding train that comes close and speeds away to person standing on the platform, is called Doppler shift of sound wave.
Doppler Spread: Doppler Spread is known as fading rate, difference between the signal frequency at the Tx & Rx with respect to time is called Doppler spread. E.g. The rate at which the train sound changes over time is called Doppler spread.
Average Delay: When signal is transmitted from multiple antenna, it reaches to receiver through multiple path reflect from surrounding clutter. In multi path scenario the average time taken to receive all the Multi path components at the receiver is known as Average Delay.
Delay Spread: Difference between the time of arrival of the earliest significant multi path component i.e. typically the line of sight (LOS) component and the time of arrival of the last multi path component is known as Delay spread.
Spatial Receiver Parameter: Spatial Receiver Parameter are refers to Beam Forming properties of Downlink received signal like dominant Angle of Arrival, average Angle of Arrival at UE.
Following table mentions 5G NR QCL Types.

| QCL type | Description |
|---|---|
| Type-A | {Doppler shift, Doppler spread, |
| | average delay, delay spread} |
| Type-B | {Doppler shift, Doppler spread} |
| Type-C | {Doppler shift, average delay} |
| Type-D | {Spatial Rx parameter} |

The large-scale properties of the channel can include one or more of: average delay, delay spread, Doppler shift, Doppler spread, and average gain. The average delay can include the first-order statistics for the time property of a channel. The delay spread can include the second-order statistics for the time property of the channel. The Doppler shift can include the first-order statistics for the frequency properties of a channel. The Doppler spread can include the second-order statistics for the frequency properties of a channel. The average gain can include the first-order statistics for the amplitude properties of the channel. The large-scale properties estimated on antenna ports of reference signals can be used to parametrize the channel estimator and compensate for possible time and frequency errors when deriving channel state information (CSI) feedback or when performing demodulation.

### Disadvantages of the Prior Art

Assistance Information of LTE and 5G-NR RS, e.g. QCL

The major disadvantage is that it utilize the commonality of different antenna ports only, other than the correlation among different antenna ports, which could help to improve channel estimation accuracy on top of reference signals.

This invention focuses on define a new channel reciprocity of assistance information for channel estimation for UL and DL RS. The information of the new channel reciprocity of assistance information for channel estimation could be exchanged between BS and UE.

### Overview of Main Points of the Present Invention

A new channel correspondence/reciprocity of assisted information for channel estimation for UL RS and DL RS,
The correspondence means that the assisted information of channel estimation for DL Rx antennas/RF chains could be reused for UL Tx antennas/RF chains.
Based on such correspondence, gNB and UE could adopt a unified configuration/indication to assist channel estimation for both DL RS and UL RS
When gNB has the capability of channel correspondence of assisted information,
   UE could assume that the assisted information among UL Rx side could be reused for channel estimation of DL RS on top of the corresponding DL Tx chains
The correspondence could be a new UE capability
When UE report the capability of channel correspondence of assisted information,
   gNB could indicate UE reuse the assisted information among DL Rx side to generate UL RS pattern
   Or gNB could apply the assisted information among DL Rx side to channel estimation of UL RS on top of the corresponding UL Tx chains

The current invention can be used to solve the channel estimation problem for T-MIMO system where there is large number for transmitter and receiver antenna ports and large bandwidth. The same method can be also applied to normal MIMO system (for example, 5G MIMO system), or even single antenna system.

By using the current invention, the following characters will show up in the system:
Require assistance information for channel estimation, which is obtained from the prior-knowledge of channel status of the target environment.
The accuracy of channel estimation will be improved based on the assistance information proposed in this ideas. The assistance information for channel estimation cloud also enable a far sparse pilot pattern(s) than traditional pilot pattern(s) (5G NR pilot design) and it could be non-uniformly distributed along time-frequency-spatial resources.

By using the current invention, the following characters will show up in the system:

### Embodiment 1

### Detailed Description of Embodiment

Assisted information for channel estimation could be
Reciprocity or correspondence of assisted information for UL RS and DL RS
Reciprocity of assistance information is an assumption that is used if the assistance information for downlink transmission RS ports and reception RF chains can also be used for uplink transmission RS ports and reception RF chains.
Example: the assisted information for UL Tx and DL Rx is reciprocal.

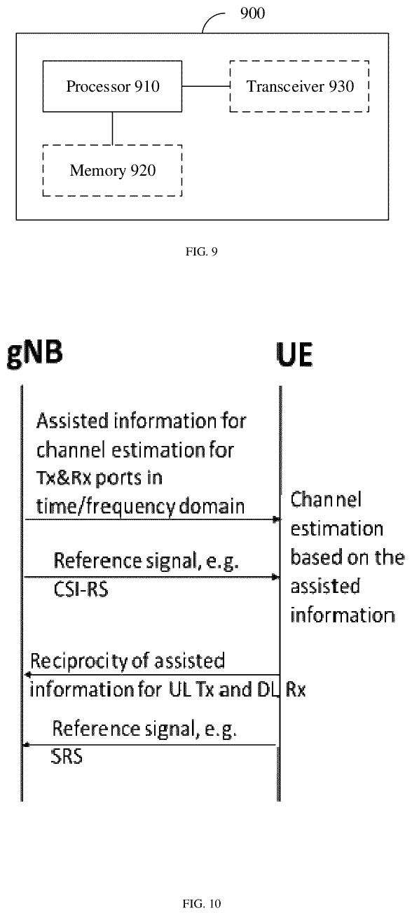

FIG. 10 is a flow chart of embodiment 1.

The methods herein are performed by a device or an apparatus, e.g. by a processor of the device or apparatus executing instructions stored in a memory. The instructions, when executed, cause the device or apparatus to perform the methods.

The various options and embodiments described herein may be combined in different permutations. Also, although the invention has been described with reference to specific features and embodiments thereof, various modifications and combinations can be made thereto without departing from the invention. The description and drawings above are, accordingly, to be regarded simply as an illustration of some embodiments of the invention, and are contemplated to cover any and all modifications, variations, combinations or equivalents.

### 6G System Structure

### 6G Basic Module Structure

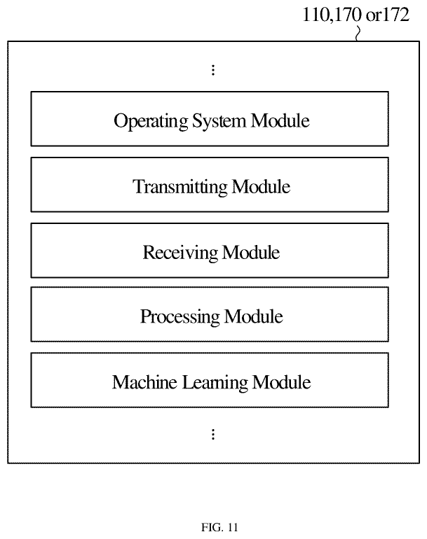

One or more steps of the embodiment methods provided herein may be performed by corresponding units or modules, according to FIG. 11. FIG. 11 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

[1] A non-exhaustive list of possible unit or possible configurable parameters or in some embodiments of a MIMO system include:

[2] Panel: unit of antenna group, or antenna array, or antenna sub-array which can control its Tx or Rx beam independently.

[3] Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

What is claimed is:

1. A method, comprising:
receiving first reference signals; and
performing a first channel estimation based on the first reference signals and first assistance information, wherein the first assistance information has a relationship with second assistance information, and a second channel estimation is based on second reference signals and the second assistance information, and wherein:
the first reference signals are downlink reference signals, and the second reference signals are uplink reference signals; or
the first reference signals are uplink reference signals, and the second reference signals are downlink reference signals.

2. The method according to claim 1, further comprising:
transmitting the second assistance information, wherein the second assistance information is determined based on the first assistance information.

3. The method according to claim 2, wherein the first reference signals are downlink reference signals, and the second reference signals are uplink reference signals.

4. The method according to claim 2, further comprising:
transmitting the second reference signals.

5. The method according to claim 4, wherein a pattern of the second reference signals is generated based on the first assistance information.

6. The method according to claim 5, further comprising:
receiving information for indicating to generate the pattern of the second reference signals based on the first assistance information.

7. The method according to claim 1, wherein the first assistance information is determined based on the second assistance information.

8. The method according to claim 1, further comprising:
transmitting or receiving capability information indicating support of a function of a correspondence between the first assistance information and the second assistance information.

9. A method, comprising:
receiving first assistance information, wherein a first channel estimation is based on first reference signals and the first assistance information; and
determining second assistance information based on the first assistance information, wherein a second channel estimation is based on second reference signals and the second assistance information, and wherein:
the first reference signals are downlink reference signals, and the second reference signals are uplink reference signals; or
the first reference signals are uplink reference signals, and the second reference signals are downlink reference signals.

10. The method according to claim 9, further comprising:
transmitting the second assistance information.

11. An apparatus, comprising:
at least one processor coupled with at least one memory storing one or more instructions that are capable of being run on the at least one processor, and wherein when the one or more instructions are run, the apparatus is enabled to:
receive first reference signals; and
perform a first channel estimation based on the first reference signals and first assistance information, wherein the first assistance information has a relationship with second assistance information, and a second channel estimation is based on second reference signals and the second assistance information, and wherein:
the first reference signals are downlink reference signals, and the second reference signals are uplink reference signals; or
the first reference signals are uplink reference signals, and the second reference signals are downlink reference signals.

12. The apparatus according to claim 11, wherein when the one or more instructions are run, the apparatus is further enabled to:
transmit the second assistance information, wherein the second assistance information is determined based on the first assistance information.

13. The apparatus according to claim 12, wherein the first reference signals are downlink reference signals, and the second reference signals are uplink reference signals.

14. The apparatus according to claim 12, wherein when the one or more instructions are run, the apparatus is further enabled to:
transmit the second reference signals.

15. The apparatus according to claim 14, wherein a pattern of the second reference signals is generated based on the first assistance information.

16. The apparatus according to claim 15, wherein when the one or more instructions are run, the apparatus is further enabled to:
receive information indicating to generate the pattern of the second reference signals based on the first assistance information.

17. The apparatus according to claim 11, wherein the first assistance information is determined based on the second assistance information.

18. The apparatus according to claim 11, wherein when the one or more instructions are run, the apparatus is further enabled to:
transmit or receive capability information indicating support of a function of a correspondence between the first assistance information and the second assistance information.

19. An apparatus, comprising:
at least one processor coupled with at least one memory storing one or more instructions that are capable of being run on the at least one processor, wherein when the one or more instructions are run, the apparatus is enabled to:
receive first assistance information, wherein a first channel estimation is based on first reference signals and the first assistance information; and
determine second assistance information based on the first assistance information, wherein a second channel estimation is based on second reference signals and the second assistance information, and wherein:
the first reference signals are downlink reference signals, and the second reference signals are uplink reference signals; or
the first reference signals are uplink reference signals, and the second reference signals are downlink reference signals.

20. The apparatus according to claim 19, wherein when the one or more instructions are run, the apparatus is further enabled to:
transmit the second assistance information.
